(19) United States
(12) Patent Application Publication
(10) Pub. No.: US 2014/0159473 A1
(43) Pub. Date: Jun. 12, 2014

(54) BRAKE SYSTEM PEDAL SIMULATOR CONNECTION

(71) Applicant: ROBERT BOSCH GMBH, Stuttgart (DE)

(72) Inventor: Ryan A. Kuhlman, Novi, MI (US)

(73) Assignee: Robert Bosch GmbH, Stuttgart (DE)

(21) Appl. No.: 13/768,478

(22) Filed: Feb. 15, 2013

Related U.S. Application Data
(60) Provisional application No. 61/735,784, filed on Dec. 11, 2012.

(51) Int. Cl. B60T 13/58

(52) U.S. Cl. CPC B60T 13/58
USPC 303/14

(57) ABSTRACT

A vehicle braking system includes a master cylinder configured to receive an input from a brake pedal. At least one wheel cylinder is operable to provide a braking force on a wheel when supplied with pressurized hydraulic fluid. A control valve is in fluid communication with both the master cylinder and the at least one wheel cylinder, and the control valve includes a piston movable by an ancillary braking actuator to provide pressurized hydraulic fluid to the at least one wheel cylinder. A pedal feel simulator is configured to provide a simulated reaction force to the brake pedal. The control valve is configured to establish fluid communication between the master cylinder and the pedal feel simulator when the piston is moved by the ancillary braking actuator.

### CROSS-REFERENCE TO RELATED APPLICATIONS

This application claims priority to U.S. Provisional Patent Application No. 61/735,784, filed Dec. 11, 2012, the entire contents of which are hereby incorporated by reference.

### BACKGROUND

The present invention relates to vehicle brake systems. More particularly, the invention relates to an arrangement for controlling a fluid connection between a brake pedal and a pedal feel simulator.

In a powered braking system 10 of FIG. 1, a master cylinder 12 is actuated with a brake pedal 14 to compress hydraulic fluid. A pedal travel sensor 16 is coupled to the brake pedal 14 and operable to detect an amount of travel of the brake pedal 14, so that a corresponding signal can be sent to a controller (not shown). The controller sends a signal to an actuator, such as an electric motor M, to control the position of a power piston 18 of a control valve 20, which is situated between the master cylinder 12 and the wheel cylinders 22. The illustrated system 10 is provided with dual circuits of two wheel cylinders 22 each, such that the control valve 20 is provided with separate pistons 18, separate inputs 26, and separate outputs 28. A solenoid valve 30 is positioned between the master cylinder 12 and each input 26 of the control valve 20 such that movement of hydraulic fluid can be selectively enabled and selectively blocked via operation of the solenoid valves 30. During normal (powered) operation, the solenoid valves 30 are closed so that the depression of the brake pedal 14 does not directly apply braking force to the wheel cylinders 22 through the hydraulic fluid, but rather, the hydraulic fluid is provided to the wheel cylinders 22 by the electric motor M moving the power piston(s) 18. A pedal feel simulator 32 is necessary to mimic the feel and travel present during braking of a conventional braking system that supplies fluid directly from the master cylinder 12 to the wheel cylinders 22. The pedal feel simulator 32 is coupled to one of the master cylinder outputs in parallel with one of the solenoid valves 30 leading to one of the control valve inputs 26. An additional solenoid valve 34 is positioned between the master cylinder 12 and the pedal feel simulator 32 to selectively enable and selectively block hydraulic fluid communication between the master cylinder 12 and the pedal feel simulator 32.

The default or “no power” state of the system 10 puts the master cylinder 12 in communication with the wheel cylinders 22 through the solenoid valves 30 (which default to open positions) and the control valve 20 (with the piston(s) 18 not actuated) so that the driver's input to the brake pedal 14 causes braking directly. However, under normal use, the brake pedal 14 and master cylinder 12 are isolated from the wheel cylinders 22 by the control valve 20 and connected instead to the pedal feel simulator 32, by switching of the valves 30, 34 at the beginning of each brake application. This necessarily leads to valve noise, which may per perceptible and undesirable to the vehicle driver and/or passengers.

### SUMMARY

In one aspect, the invention provides a vehicle braking system including a master cylinder configured to receive an input from a brake pedal. At least one wheel cylinder is operable to provide a braking force on a wheel when supplied with pressurized hydraulic fluid. A control valve is in fluid communication with both the master cylinder and the at least one wheel cylinder, and the control valve includes a piston movable by an ancillary braking actuator to provide pressurized hydraulic fluid to the at least one wheel cylinder. A pedal feel simulator is configured to provide a simulated reaction force to the brake pedal. The control valve is configured to establish fluid communication between the master cylinder and the pedal feel simulator when the piston is moved by the ancillary braking actuator.

In another aspect, the invention provides a vehicle braking system including a master cylinder configured to receive an input from a brake pedal. At least one wheel cylinder is operable to provide a braking force on a wheel when supplied with pressurized hydraulic fluid. A pedal feel simulator is configured to provide a reaction force to the brake pedal. A control valve has a first port coupled to the master cylinder, a second port coupled to the at least one wheel cylinder, and a third port coupled to the pedal feel simulator. The control valve includes a piston movable by an ancillary braking actuator. The first and second ports are in fluid communication with each other through a first chamber of the control valve when the piston is in a first position, and wherein movement of the piston away from the first position simultaneously breaks the fluid communication between the first and second ports and establishes fluid communication between the first and third ports.

### BRIEF DESCRIPTION OF THE DRAWINGS

FIG. 1 is a schematic drawing of a braking system with a powered control valve and a pedal simulator.

FIG. 2 is a cross-sectional view of a control valve within a braking system, according to one aspect of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

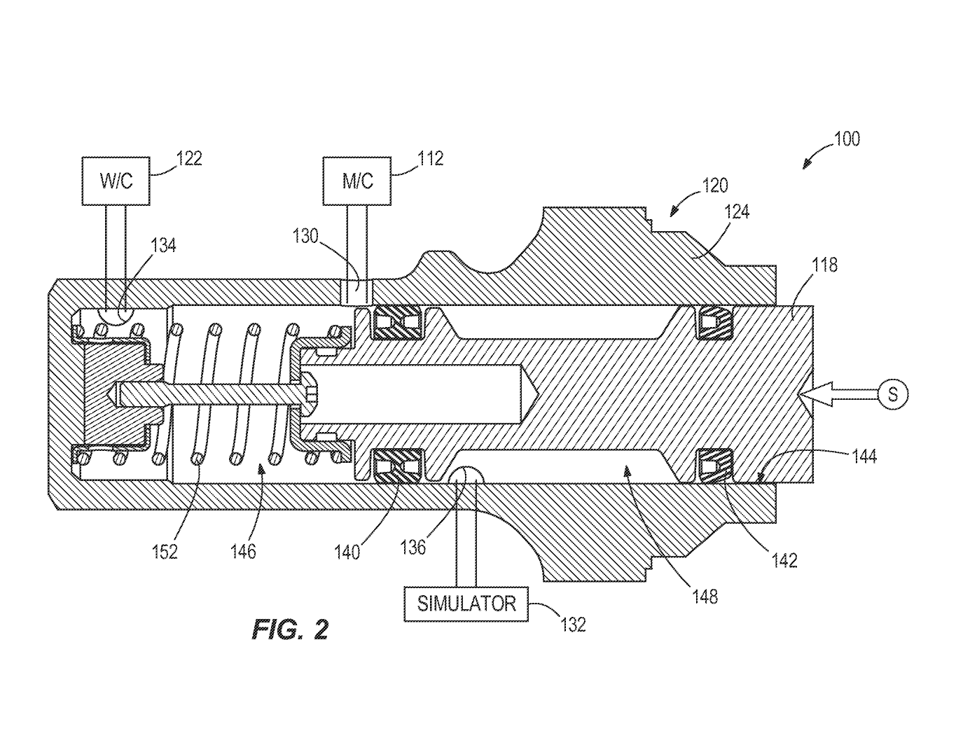

FIG. 2 illustrates a braking system 100 that utilizes a brake-applying control valve 120 to control fluid communication between a master cylinder 112 and both the service brakes, which include one or more wheel cylinder(s) 122, and a pedal feel simulator 132. The braking system 100 is a “full-power braking system” whereby the wheel cylinders 122 are actuated by a piston 118 of the control valve 120 powered by an ancillary actuator or power source S rather than the master cylinder 112. In other words, the master cylinder 112 is cut off from fluid communication with the wheel cylinders 122, and 100 percent of the braking pressure is provided from the ancillary source S and the piston 118 under normal operation (i.e., after an initial movement of the piston 118). The ancillary source S can be an electromechanical actuator (e.g., an electric motor and gear/screw mechanism), or an alternate means such as pressure (e.g., fluid pressure) supplied to the back side of the piston 118, or any other means of linearly moving a piston. As described in further detail below, while in the course of applying braking force from the ancillary source S, the initial movement of the piston 118 both breaks a fluid connection between the master cylinder 112 and the wheel cylinder(s) 122 and establishes a fluid connection between the master cylinder 112 and the pedal feel simulator 132.

The control valve 120 includes a housing 124 which substantially encloses the piston 118. The housing 124 has a first port 130 fluidly coupled to the output of the master cylinder 112, a second port 134 fluidly coupled to the wheel cylinder(s) 122 of the service brakes (which may be split into multiple, independent circuits), and a third port 136 fluidly coupled to the pedal simulator 132. First and second seals 140, 142 on the piston 118 contact an interior bore 144 of the housing 124 to define first and second chambers 146, 148 within the housing 124 of the control valve 120. The interior bore 144 may be between about 20 millimeters and about 31 millimeters in diameter for most typical vehicle applications. As illustrated in FIG. 2, a spring 152 biases the piston 118 to an at-rest or default position when the piston 118 is not being actuated by the ancillary source S. In this position, the first seal 140 is positioned within the bore 144 to fluidly separate the first (master cylinder) port 130 from the third (pedal simulator) port 136. The first port 130 is in fluid communication with the second (wheel cylinder) port 134 via the first chamber 146. If the ancillary source S loses the ability to actuate the piston 118 against the bias of the spring 152, the piston 118 remains in the position of FIG. 2, whereby hydraulic fluid can be supplied to the wheel cylinder(s) 122 from the master cylinder 112 by application of a brake pedal connected thereto.

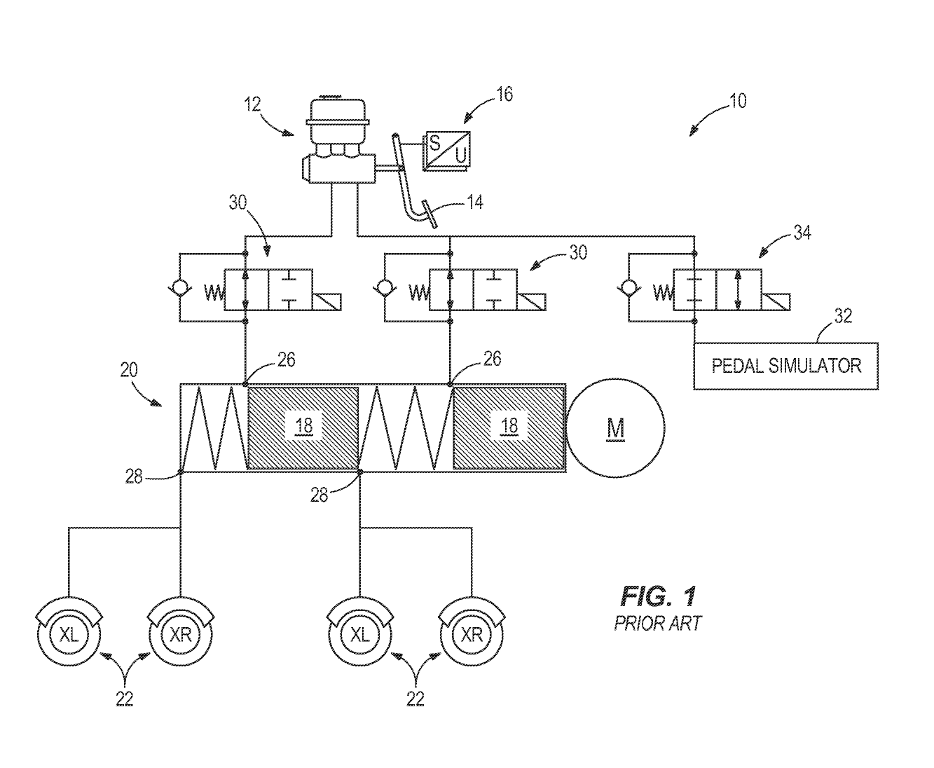

However, under normal operation, the initial application of the brake pedal is sensed by a pedal travel sensor similar to the arrangement shown in FIG. 1, and the piston 118 is moved by the ancillary source S as controlled by a controller (not shown). Upon initial movement of the piston 118 from the at-rest position of FIG. 2, against the bias of the spring 152, the first seal 140 traverses the first (master cylinder) port 130 so that the port 130 goes from being in fluid communication with the first chamber 146 to being in fluid communication with the second chamber 148. In doing so, fluid communication is cut off between the master cylinder 112 and the wheel cylinder(s) 122, and fluid communication is established between the master cylinder 112 and the pedal feel simulator 132, entirely through the control valve 120. As soon as the master cylinder 112 is cut off from the wheel cylinder(s) 122 and coupled with the pedal feel simulator 132, braking to the wheel cylinder(s) 122 is carried out entirely by the piston 118 as powered by the ancillary source S, while the feedback to the master cylinder 112 and brake pedal is provided by the pedal feel simulator 132. This is referred to as full-power braking, in the sense that the entire braking force is being generated by the ancillary source S, which is not physically powered by a driver's input on the brake pedal to the master cylinder 112.

The solution involves utilizing a small initial movement of the piston 118 to hydraulically couple the pedal circuit (i.e., the brake pedal and master cylinder 112) to the pedal feel simulator 132 and simultaneously isolate the pedal circuit from the wheel cylinder(s) 122. By simultaneous, it is meant that these actions take place substantially at the same time, but furthermore, it is noted that these actions take place by a single action or movement of the piston 118 that causes the seal 140 to traverse the first port 130. In some constructions, the small initial movement can perform the above-mentioned actions within the first 10 to 20 percent of the total piston stroke. For example, movement of the piston 118 of about 2.5 millimeters from the at-rest position can hydraulically couple the pedal circuit to the pedal feel simulator 132 and isolate the pedal circuit from the wheel cylinder(s) 122 (e.g., the first port 130 is closed off from the first chamber 146 within the first 2.0 millimeters of piston travel and fluid communication between the first port 130 and the second chamber 148 is established within about another 0.5 millimeter). After this initial travel, the working range of the piston 118 can be about 12 millimeters to about 20 millimeters. In some alternate constructions, the initial movement of the piston 118 referred to above can be less than 10 percent of the total piston stroke. It should be noted that the control valve 120 shown in FIG. 2 is provided for the purpose of aiding understanding of the invention, and should not be taken as limiting the scope of the invention with respect to dimensions or relative dimensions.

The system 100 and associated control valve 120 shown in FIG. 2 is provided with a single circuit for the service brakes, however an additional piston (e.g., “floating piston”) can be added to selectively cut off fluid communication between the master cylinder 112 and a secondary service brake circuit coupled to an additional port of the housing 124 provided in communication with an additional chamber. The only difference from the illustrated primary circuit connection is that the secondary circuit connection does not need a port to the pedal feel simulator 132 since one is already provided. This alternate design, while contemplated, is not shown only for simplicity. Various features and advantages of the invention are set forth in the following claims.

What is claimed is:

1. A vehicle braking system comprising:
a master cylinder configured to receive an input from a brake pedal;
at least one wheel cylinder operable to provide a braking force on a wheel when supplied with pressurized hydraulic fluid;
a control valve in fluid communication with both the master cylinder and the at least one wheel cylinder, wherein the control valve includes a piston movable by an ancillary braking actuator to provide pressurized hydraulic fluid to the at least one wheel cylinder; and
a pedal feel simulator configured to provide a simulated reaction force to the brake pedal,
wherein the control valve is configured to establish fluid communication between the master cylinder and the pedal feel simulator when the piston is moved by the ancillary braking actuator.

2. The vehicle braking system of claim 1, wherein the pedal feel simulator is fluidly coupled to the master cylinder exclusively through the control valve, exclusively when the piston of the control valve is moved away from an at-rest position into an actuated position.

3. The vehicle braking system of claim 2, wherein the piston is biased to the at-rest position.

4. The vehicle braking system of claim 3, wherein a first port of the control valve, coupled to the master cylinder, is in fluid communication with a second port of the control valve, coupled to the at least one wheel cylinder, via a first chamber of the control valve when the piston is in the at-rest position.

5. The vehicle braking system of claim 4, wherein the pedal feel simulator is coupled to a third port of the control valve in fluid communication with a second chamber of the control valve, the second chamber being separated from the first chamber by a first piston seal.

6. The vehicle braking system of claim 5, wherein the first piston seal is configured to traverse the first port upon an initial movement of the piston from the at-rest position.

7. The vehicle braking system of claim 6, wherein the initial movement of the piston is no more than about 2.5 millimeters.

8. The vehicle braking system of claim 1, wherein the ancillary braking actuator includes an electromechanical actuator.

9. The vehicle braking system of claim 1, wherein the ancillary braking actuator includes a source of pressurized fluid.

10. The vehicle braking system of claim 1, wherein the vehicle braking system is a full-power braking system operable to isolate the master cylinder from the at least one wheel cylinder and provide all braking power to the at least one wheel cylinder via the ancillary braking actuator and the control valve piston.

11. A vehicle braking system comprising:
a master cylinder configured to receive an input from a brake pedal;
at least one wheel cylinder operable to provide a braking force on a wheel when supplied with pressurized hydraulic fluid;
a pedal feel simulator configured to provide a reaction force to the brake pedal; and
a control valve having a first port coupled to the master cylinder, a second port coupled to the at least one wheel cylinder, and a third port coupled to the pedal feel simulator, wherein the control valve includes a piston movable by an ancillary braking actuator,
wherein the first and second ports are in fluid communication with each other through a first chamber of the control valve when the piston is in a first position, and wherein movement of the piston away from the first position simultaneously breaks the fluid communication between the first and second ports and establishes fluid communication between the first and third ports.

12. The vehicle braking system of claim 11, wherein the pedal feel simulator is fluidly coupled to the master cylinder exclusively through the control valve, exclusively when the piston of the control valve is moved away from the first position.

13. The vehicle braking system of claim 12, wherein the piston is biased to the first position.

14. The vehicle braking system of claim 11, wherein the fluid communication between the first and third ports is established through a second chamber of the control valve, the second chamber being separated from the first chamber by a first piston seal.

15. The vehicle braking system of claim 14, wherein the first piston seal is configured to traverse the first port upon an initial movement of the piston from the first position.

16. The vehicle braking system of claim 15, wherein the initial movement of the piston is no more than about 2.5 millimeters.

17. The vehicle braking system of claim 11, wherein the piston is movable from the first position exclusively by the ancillary braking actuator.

18. The vehicle braking system of claim 11, wherein the ancillary braking actuator includes an electromechanical actuator.

19. The vehicle braking system of claim 11, wherein the ancillary braking actuator includes a source of pressurized fluid.

20. The vehicle braking system of claim 11, wherein the vehicle braking system is a full-power braking system operable to isolate the master cylinder from the at least one wheel cylinder and provide all braking power to the at least one wheel cylinder via the ancillary braking actuator and the control valve piston.
